(19) United States
(12) Patent Application Publication
(10) Pub. No.: US 2025/0067191 A1
(43) Pub. Date: Feb. 27, 2025

(54) SEALING AND BALANCING OF GAS TURBINE ENGINE

(71) Applicant: Pratt & Whitney Canada Corp., Longueuil (CA)

(72) Inventors: Philippe Savard, Montréal (CA); Guy Lefebvre, St-Bruno (CA)

(21) Appl. No.: 18/452,925

(22) Filed: Aug. 21, 2023

(51) Int. Cl. F01D 11/00

(52) U.S. Cl. CPC F01D 11/001; F01D 5/027; F05D 2240/55

(57) ABSTRACT

A rotor of a gas turbine engine includes a rotor hub rotatable about a rotor central axis, a plurality of rotor blades extending radially outwardly from the rotor hub, and a rotor flange extending axially from the rotor hub. The rotor flange at least partially defines a seal assembly configured to seal between the rotor and a static structure of the gas turbine engine, and a rotor balancing structure configured to rotationally balance the rotor.

### BACKGROUND

Exemplary embodiments pertain to the art of gas turbine engines, and in particular to balancing of turbine rotors and rotor assemblies of gas turbine engines.

Cavities in gas turbine engines, for example, cavities between turbine rotors, need to be sealed to ensure a proper air pressure distribution along the gas turbine engine flow path. Seals are utilized at interstage locations in the turbine assembly located radially between a rotating component such as a turbine rotor, and a stationary component such as a turbine stator. Further, the turbine rotors require balancing as a component, and as part of a turbine assembly in order to ensure performance characteristics of the gas turbine engine.

### BRIEF DESCRIPTION

In one exemplary embodiment, a rotor of a gas turbine engine includes a rotor hub rotatable about a rotor central axis, a plurality of rotor blades extending radially outwardly from the rotor hub, and a rotor flange extending axially from the rotor hub. The rotor flange at least partially defines a seal assembly configured to seal between the rotor and a static structure of the gas turbine engine, and a rotor balancing structure configured to rotationally balance the rotor.

Additionally or alternatively, in this or other embodiments the seal assembly includes a labyrinth seal having a seal base positioned at the rotor flange, and a plurality of seal fins extending from the seal base toward the static structure to define a seal interface between the plurality of seal fins and the static structure.

Additionally or alternatively, in this or other embodiments the plurality of seal fins extend radially outwardly from the rotor flange.

Additionally or alternatively, in this or other embodiments the rotor balancing structure includes a balancing flange extending from the rotor flange.

Additionally or alternatively, in this or other embodiments the balancing flange extends radially inwardly from the rotor flange.

Additionally or alternatively, in this or other embodiments the balancing flange extends from an axial end of the rotor flange.

Additionally or alternatively, in this or other embodiments the rotor balancing structure further includes one or more counterweights secured to the balancing flange.

In another exemplary embodiment, a turbine of a gas turbine engine includes a turbine static structure, and a turbine rotor located at and rotatable about a turbine central axis. The turbine rotor includes a turbine rotor hub located at the turbine central axis, a plurality of rotor blades extending radially outwardly from the turbine rotor hub, and a turbine rotor flange extending axially from the turbine rotor hub. The turbine rotor flange at least partially defines a seal assembly configured to seal between the turbine rotor and the turbine static structure, and a rotor balancing structure configured to rotationally balance the turbine rotor.

Additionally or alternatively, in this or other embodiments the seal assembly includes a labyrinth seal having a seal base positioned at the turbine rotor flange, and a plurality of seal fins extending from the seal base toward the static structure to define a seal interface between the plurality of seal fins and the turbine static structure.

Additionally or alternatively, in this or other embodiments the plurality of seal fins extend radially outwardly from the turbine rotor flange.

Additionally or alternatively, in this or other embodiments the rotor balancing structure includes a balancing flange extending from the turbine rotor flange.

Additionally or alternatively, in this or other embodiments the balancing flange extends radially inwardly from the turbine rotor flange.

Additionally or alternatively, in this or other embodiments the balancing flange extends from an axial end of the turbine rotor flange.

Additionally or alternatively, in this or other embodiments the rotor balancing structure further includes one or more counterweights secured to the balancing flange.

Additionally or alternatively, in this or other embodiments the turbine stating structure is a turbine frame.

In yet another exemplary embodiment, a gas turbine engine includes a combustor configured to combust a mixture of air and fuel, and a turbine assembly including a turbine rotor driven to rotate about an engine central axis by a flow of combustion gases from the combustor. The turbine rotor includes a turbine rotor hub located at the turbine central axis, a plurality of rotor blades extending radially outwardly from the turbine rotor hub, and a turbine rotor flange extending axially from the turbine rotor hub. The turbine rotor flange at least partially defines a seal assembly configured to seal between the turbine rotor and a turbine static structure, and a rotor balancing structure configured to rotationally balance the turbine rotor.

Additionally or alternatively, in this or other embodiments the seal assembly includes a labyrinth seal having a seal base located at the turbine rotor flange, and a plurality of seal fins extending from the seal base toward the static structure to define a seal interface between the plurality of seal fins and the turbine static structure.

Additionally or alternatively, in this or other embodiments the plurality of seal fins extend radially outwardly from the turbine rotor flange.

Additionally or alternatively, in this or other embodiments the rotor balancing structure includes a balancing flange extending radially inwardly from the turbine rotor flange.

Additionally or alternatively, in this or other embodiments the rotor balancing structure further includes one or more counterweights secured to the balancing flange.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of a gas turbine engine;

FIG. 2 is a partial cross-sectional view of an embodiment of a turbine rotor of a gas turbine engine; and

FIG. 3 is a partial cross-sectional view of another embodiment of a turbine rotor of a gas turbine engine.

### DETAILED DESCRIPTION

A detailed description of one or more embodiments of the disclosed apparatus and method are presented herein by way of exemplification and not limitation with reference to the Figures.

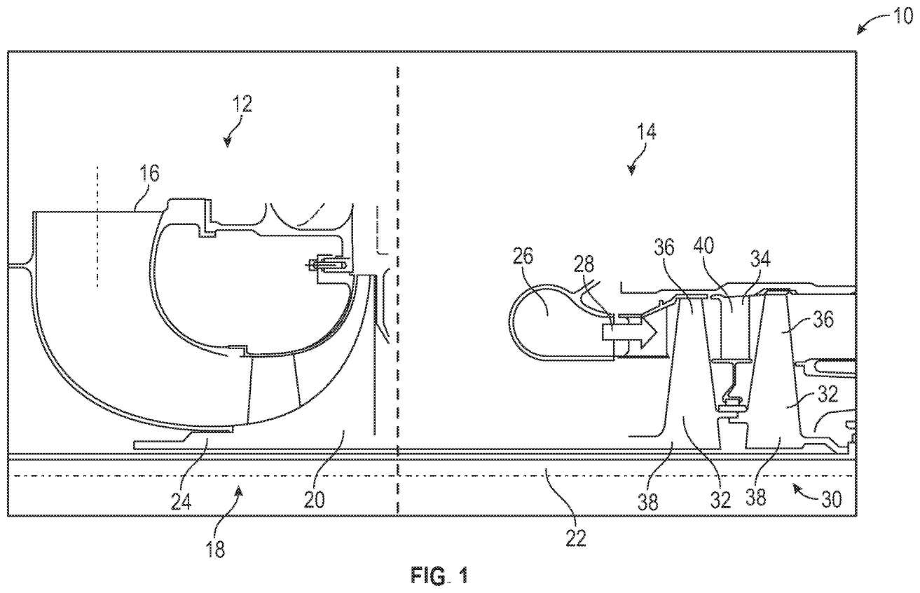

Illustrated in FIG. 1 is an embodiment of a gas turbine engine 10. The engine generally includes a compressor section 12 and a hot section 14. The compressor section 12 includes an inlet 16 and a compressor 18 having a compressor rotor 20 rotatable about an engine central axis 22. In some embodiments, the compressor rotor 20 is mounted on a compressor shaft 24 located at the engine central axis 22. In some embodiments, such as illustrated in FIG. 1, the compressor 18 is a centrifugal compressor 18 and the compressor rotor 20 is an impeller. One skilled in the art, however, will readily appreciate that the gas turbine engine 10 may include other types of compressor 18, for example, an axial compressor.

The hot section 14 includes a combustor 26 at which compressed airflow output from the compressor 18 is mixed with a fuel and combusted, producing hot combustion gases 28, which are directed to a turbine 30. The turbine 30 includes one or more turbine rotors 32 rotatable about the engine central axis 22 and one or more turbine stators 34 located axially adjacent to the one or more turbine rotors 32. The turbine rotors 32 include a plurality of turbine blades 36 fixed to a rotor hub 38. The one or more turbine stators 34 are fixed relative to the engine central axis 22 and include a plurality of stator vanes 40. The hot combustion gases 28 drive rotation of the turbine rotors 32, which drives rotation of the compressor rotor 20 and provides thrust for the gas turbine engine 10.

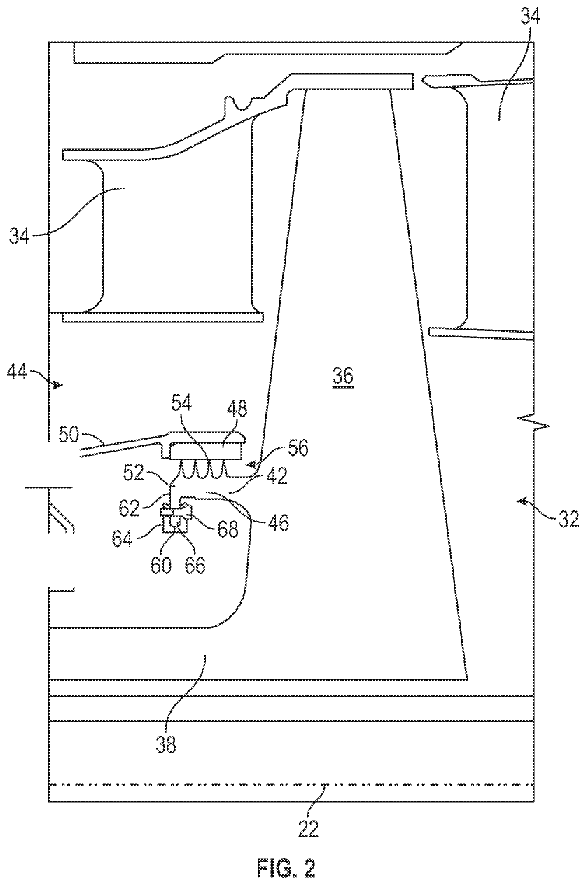

Referring to FIG. 2, illustrated is an example of a turbine rotor 32. The turbine rotor 32, in addition to the rotor hub 38 and the plurality of turbine blades 36 extending radially outwardly from the rotor hub 38, includes at least one rotor flange 42 extending in an axial direction from the rotor hub 38. In some embodiments, such as shown, the rotor flange 42 extends axially forward or upstream from the rotor hub 38. One skilled in the art, however, will readily appreciate that the rotor flange 42 may similarly extend axially rearward or downstream from the rotor hub 38.

A seal assembly 44 is positioned at the rotor flange 42. In the embodiment of FIG. 2, the seal assembly 44 includes a rotating seal element 46 at the rotor flange 42, which rotates with the turbine rotor 32. Additionally, the seal assembly 44 includes a rotationally stationary seal element 48 located at a stationary component of the gas turbine engine 10, such as a frame 50 as illustrated, or in other embodiments at a casing flange or at a turbine stator 34. In the embodiment of FIG. 2, the stationary seal element 48 is located radially outboard of the rotating seal element 46, while in other embodiments the configuration may be substantially reversed, so that the stationary seal element 48 is located radially inboard of the rotating seal element 46. The rotating seal element 46 is, in some embodiments, a labyrinth seal element 46. The labyrinth seal element 46 includes a seal base 52 and a plurality of seal fins 54 extending from the seal base 52 toward the stationary seal element 48, in this embodiment in a radially outwardly direction, to define a seal interface 56.

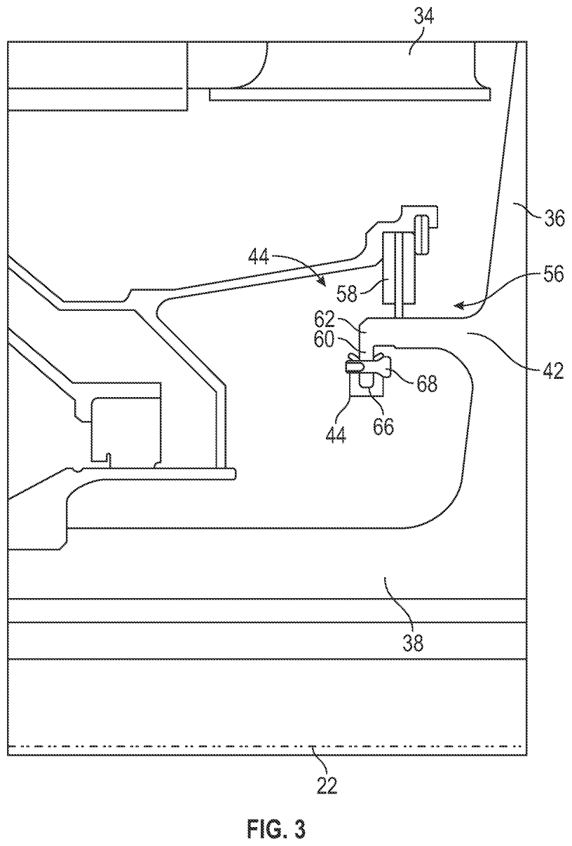

In other embodiments, the seal assembly 44 may be another configuration, for example, such as a brush seal assembly 44 as illustrated in FIG. 3. In the embodiment of FIG. 3, a brush seal element 58 is secured to the frame 50 and extends toward the rotor flange 42 to define the seal interface 56 between the brush seal element 58 and the rotor flange 42. One skilled in the art will readily appreciate that these seal configurations are merely exemplary and that other seal assembly 44 configurations may be utilized.

Referring again to FIG. 2, the same rotor flange 42 at which the seal assembly 44 is located also includes a balancing flange 60 extending therefrom. In some embodiments, such as illustrated, the balancing flange 60 extends in a radial direction from a distal flange end 62 of the rotor flange 42. In embodiments where the seal fins 54 extend radially outwardly toward the frame 50, the balancing flange 60 may extend radially inwardly toward the engine central axis 22 and away from the frame 50. The balancing flange 60 is utilized to rotationally balance the turbine rotor 32 by, for example, the installation of one or more counterweights 64 to the balancing flange 60 and/or via selective removal of material from the balancing flange 60. The counterweights 64 have a U-shaped cross-section and fit to a balancing flange end 66. The counterweights 64 are secured to the balancing flange 60 by, for example, one or more counterweight bolts 68 or other fasteners extending through the counterweight 64 and through the balancing flange 60.

Combining the sealing functions and balancing functions into the same rotor flange 42 via the seal assembly 44 and the balancing flange 60 reduces the axial space occupied by the turbine rotor 32, and reduces complexity of the turbine rotor 32. Further, this allows for optimal radial position of both the seal assembly 44 and the balancing flange 60. Additionally, while the present description present the features in the context of a turbine rotor 32, one skilled in the art will appreciate that the configurations of the present disclosure may be similarly applied to other rotating components such as compressor rotors 20.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

Please amend/replace the claims as follows:

1. A rotor of a gas turbine engine, comprising:
a rotor hub rotatable about a rotor central axis;
a plurality of rotor blades extending radially outwardly from the rotor hub; and
a rotor flange extending axially from the rotor hub, the rotor flange at least partially defining:
a seal assembly including a seal element of the rotor flange configured to seal between the rotor and a static structure of the gas turbine engine; and
a rotor balancing structure configured to rotationally balance the rotor;
wherein the rotor balancing structure comprises a balancing flange extending radially inwardly from an axially distal end of the rotor flange; and
one or more counterweights secured to the balancing flange by one or more fasteners extending through the counterweight and through the balancing flange.

2. The rotor of claim 1, wherein the seal assembly comprises a labyrinth seal including:
a seal base disposed at the rotor flange; and
a plurality of seal fins configured to extend from the seal base toward the static structure to define a seal interface between the plurality of seal fins and the static structure.

3. The rotor of claim 2, wherein the plurality of seal fins extend radially outwardly from the rotor flange.

4. (canceled)

5. (canceled)

6. (canceled)

7. (canceled)

8. A turbine of a gas turbine engine, comprising:
a turbine static structure; and
a turbine rotor disposed at and rotatable about a turbine central axis, the turbine rotor including:
a turbine rotor hub located at the turbine central axis;
a plurality of rotor blades extending radially outwardly from the turbine rotor hub; and
a turbine rotor flange extending axially from the turbine rotor hub, the turbine rotor flange at least partially defining:
a seal assembly including a seal element of the rotor flange configured to seal between the turbine rotor and the turbine static structure; and
a rotor balancing structure configured to rotationally balance the turbine rotor;
wherein the rotor balancing structure comprises a balancing flange extending radially inwardly from an axially distal end of the rotor flange; and
one or more counterweights secured to the balancing flange by one or more fasteners extending through the counterweight and through the balancing flange.

9. The turbine of claim 8, wherein the seal assembly comprises a labyrinth seal including:
a seal base disposed at the turbine rotor flange; and
a plurality of seal fins extending from the seal base toward the static structure to define a seal interface between the plurality of seal fins and the turbine static structure.

10. The turbine of claim 9, wherein the plurality of seal fins extend radially outwardly from the turbine rotor flange.

11. (canceled)

12. (canceled)

13. (canceled)

14. (canceled)

15. The turbine of claim 8, wherein the turbine static structure is a turbine frame.

16. A gas turbine engine, comprising:
a combustor configured to combust a mixture of air and fuel; and
a turbine assembly including:
a turbine rotor driven to rotate about an engine central axis by a flow of combustion gases from the combustor, the turbine rotor including:
a turbine rotor hub located at the engine central axis;
a plurality of rotor blades extending radially outwardly from the turbine rotor hub; and
a turbine rotor flange extending axially from the turbine rotor hub, the turbine rotor flange at least partially defining:
a seal assembly including a seal element of the rotor flange configured to seal between the turbine rotor and a turbine static structure; and
a rotor balancing structure configured to rotationally balance the turbine rotor;
wherein the rotor balancing structure comprises a balancing flange extending radially inwardly from an axially distal end of the rotor flange; and
one or more counterweights secured to the balancing flange by one or more fasteners extending through the counterweight and through the balancing flange.

17. The gas turbine engine of claim 16, wherein the seal assembly comprises a labyrinth seal including:
a seal base disposed at the turbine rotor flange; and
a plurality of seal fins extending from the seal base toward the static structure to define a seal interface between the plurality of seal fins and the turbine static structure.

18. The gas turbine engine of claim 17, wherein the plurality of seal fins extend radially outwardly from the turbine rotor flange.

19. (canceled)

20. (canceled)
